(19) United States
(12) Patent Application Publication
(10) Pub. No.: US 2026/0270807 A1
(43) Pub. Date: Sep. 10, 2026

(54) METHOD AND APPARATUS FOR USER EQUIPMENT CAPABILITY REPORTING FOR LAYER-1 OR LAYER-2 TRIGGERED MOBILITY IN MOBILE COMMUNICATIONS

(71) Applicant: MEDIATEK INC., Hsinchu City (TW)

(72) Inventors: Din-Hwa HUANG, Hsinchu City (TW); Hsien-Ping LIN, San Jose, CA (US); Li-Chuan TSENG, Hsinchu City (TW)

(21) Appl. No.: 19/165,971

(22) PCT Filed: May 11, 2024
(86) PCT No.: PCT/CN2024/092624

§ 371 Date: Sep. 16, 2025

Related U.S. Application Data
(60) Provisional application No. 63/501,686, filed on May 12, 2023.

(51) Int. Cl. H04W 36/00; H04W 36/08

(52) U.S. Cl. CPC H04W 36/0058; H04W 36/0072; H04W 36/008355; H04W 36/0085; H04W 36/08

(57) ABSTRACT

Various solutions for user equipment (UE) capability reporting for layer-1 (L1) or layer-2 (L2) triggered mobility (LTM) in mobile communications are described. An apparatus may report a first capability indicating a maximum number of cells for L1 measurement to a network node of a wireless network. Then, the apparatus may receive a configuration of one or more candidate cells for LTM from the network node. The configuration is configured based on the first capability. Also, the apparatus may perform L1 measurements on the candidate cells according to the configuration.

### CROSS REFERENCE TO RELATED PATENT APPLICATION(S)

The present disclosure is part of a non-provisional application claiming the priority benefit of U.S. Patent Application No. 63/501,686, filed 12 May 2023, the content of which herein being incorporated by reference in its entirety.

### TECHNICAL FIELD

The present disclosure is generally related to mobile communications and, more particularly, to user equipment (UE) capability reporting for layer-1 (L1) or layer-2 (L2) triggered mobility (LTM) in mobile communications.

### BACKGROUND

Unless otherwise indicated herein, approaches described in this section are not prior art to the claims listed below and are not admitted as prior art by inclusion in this section.

In mobile communications, handover refers a process of transferring an ongoing communication session of a UE from one cell to another in connected state, such that seamless connectivity and continuity of service for the user can be ensured, especially when the user is on the move. In 3^{rd} Generation Partnership Project (3GPP) until Release 17, a cell switch (or called a serving cell change) is triggered by layer-3 (L3) measurements and performed by radio resource control (RRC) signaling. This L3-based mobility involves reconfiguration of upper layers (e.g., RRC layer and/or packet data convergence protocol (PDCP) layer) and resetting of lower layers (e.g., medium access control (MAC) layer and/or physical (PHY) layer), which inevitably leads to long latency, large signaling overhead, and long interruption time.

To reduce the latency, signaling overhead, and interruption time during handover, 3GPP Release 18 has introduced a lower-layer-based mobility (or called LTM) which aims to enable a cell switch via L1/L2 signaling, while keeping configuration of the upper layers and/or minimizing changes of configuration of the lower layers. However, as LTM is a newly introduced feature, many details of LTM have not been fully discussed. For example, a UE is expected to perform fine time/frequency (T/F) tracking on the serving cell(s) and also the candidate cells, which consequently increases UE complexity. Accordingly, how to configure the candidate cells such that the UE is capable of performing fine T/F tracking on the configured candidate cells has become an important issue for newly developed wireless communication systems.

Therefore, there is a need to provide proper schemes and designs to solve this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to candidate cell configuration with support of UE's capability.

In one aspect, a method may involve an apparatus reporting a first capability indicating a maximum number of cells for L1 measurement to a network node of a wireless network. The method may also involve the apparatus receiving a configuration of one or more candidate cells for LTM from the network node. The configuration is configured based on the first capability. The method may further involve the apparatus performing L1 measurements on the candidate cells according to the configuration.

In one aspect, an apparatus may comprise a transceiver which, during operation, wirelessly communicates with a network node of a wireless network. The apparatus may also comprise a processor communicatively coupled to the transceiver. The processor, during operation, may perform operations comprising reporting, via the transceiver, a first capability indicating a maximum number of cells for L1 measurement to the network node. The processor may also perform operations comprising receiving, via the transceiver, a configuration of one or more candidate cells for LTM from the network node. The configuration is configured based on the first capability. The processor may further perform operations comprising performing, via the transceiver, L1 measurements on the candidate cells according to the configuration.

In one aspect, a method may involve a network node receiving a first capability indicating a maximum number of cells for L1 measurement from an apparatus. The method may also involve the network node transmitting a configuration of one or more candidate cells for LTM to the apparatus. The configuration is configured based on the first capability.

It is noteworthy that, although description provided herein may be in the context of certain radio access technologies (RATs), networks and network topologies such as Long-Term Evolution (LTE), LTE-Advanced, LTE-Advanced Pro, 5G, New Radio (NR), Internet-of-Things (IoT) and Narrow Band Internet of Things (NB-IoT), Industrial Internet of Things (IIoT), beyond 5G (B 5 G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario of interruption reduction in cell switch in accordance with an implementation of the present disclosure.

FIG. 3 is a diagram depicting an example scenario of DL and UL synchronizations towards candidate cell(s) before the cell switch command in accordance with an implementation of the present disclosure.

FIG. 4 is a diagram depicting an example scenario of UE capability reporting for LTM in accordance with an implementation of the present disclosure.

FIG. 5 is a block diagram of an example communication system in accordance with an implementation of the present disclosure.

FIG. 6 is a flowchart of an example process in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to UE capability reporting for LTM in mobile communications. According to the present disclosure, a number of possible solutions may be implemented separately or jointly. That is, although these possible solutions may be described below separately, two or more of these possible solutions may be implemented in one combination or another.

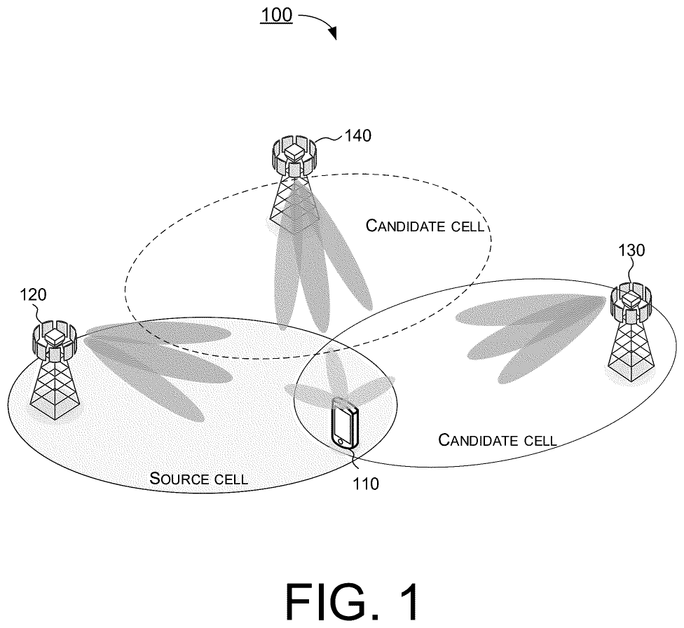

FIG. 1 illustrates an example scenario 100 of a communication environment in which various solutions and schemes in accordance with the present disclosure may be implemented. Scenario 100 involves a UE 110 in wireless communication with one or more network nodes 120, 130, and 140 (e.g., a base station (BS) such as an evolved Node-B (eNB), a Next Generation Node-B (gNB), a transmission/reception point (TRP), or a radio unit (RU)). The network node 120 forms a serving cell for the UE 110 (i.e., establishes a connection with the UE 110), which is also called a source cell in terms of potential cell change due to UE mobility. In addition, there may be multiple neighboring cells around the source cell, including the cells formed by the network nodes 130 and 140, which are also called candidate cells that the UE 110 may switch to during an LTM procedure. The UE 110 is in the overlapping service area of the network nodes 120 and 130, and may switch back and forth between the network nodes 120 and 130 during an LTM procedure. Although not shown, the network nodes 120, 130, and 140 may be coupled to a controller forming a radio access network (RAN) that is coupled to one or more core networks, through a network entity, such as a mobility management entity (MME) or a serving gateway (SGW) in 4G LTE, or an access and mobility management function (AMF) or a user plane function (UPF) in 5G NR. In such communication environment, the UE 110 and the network nodes 120, 130, and 140 may implement various schemes pertaining to UE capability reporting for LTM in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

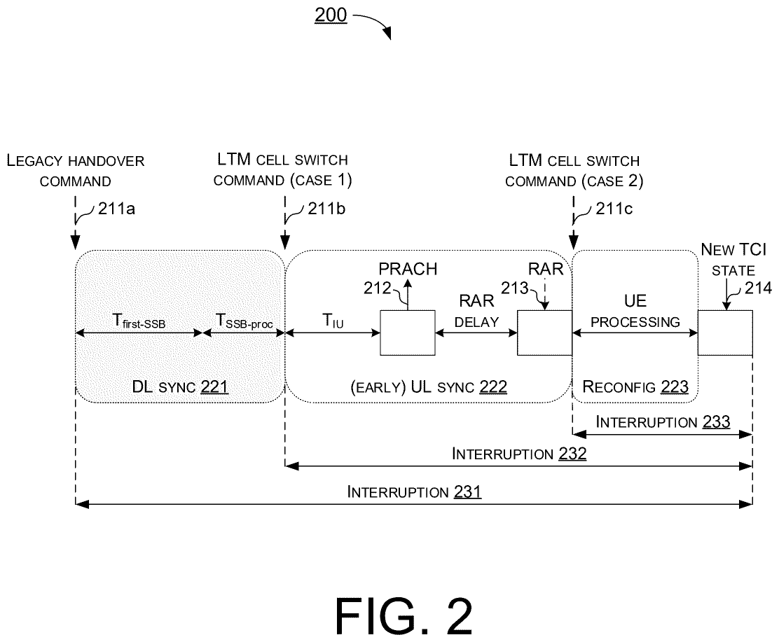

FIG. 2 illustrates an example scenario 200 of interruption reduction in cell switch in accordance with an implementation of the present disclosure. For a legacy handover, a handover command (e.g., an RRC Reconfiguration message) is received by the UE at step 211a for cell switch. The interruption 231 for legacy handover starts when the traditional handover command is received and the UE performs DL synchronization 221, UL synchronization 222, reconfiguration 223, and processing for new transmission configuration indicator (TCI) state. With the development of LTM, the UE may receive pre-configuration for LTM before the cell switch command 211b/c is received. The cell switch command 211b/c may be a MAC control element (CE) triggering a cell switch from the source cell to a candidate cell. In the first case of LTM, the UE performs DL synchronization 221 before receiving the cell switch command 211b, such that the synchronization signal/PBCH block (SSB) receiving and processing time T_{first-SSB} and T_{SSB-proc} for DL synchronization 221 can be saved. That is, the interruption 232 for the first case of LTM is reduced from the interruption 231 of the legacy handover. In the second case of LTM, the early UL synchronization 222 is performed before the cell switch command 211c. The interruption 233 for the second case of LTM is reduced from interruption 231 for the legacy handover and further reduced from interruption 232 for the first case of LTM. The early UL synchronization 222 includes the interruption uncertainty T_{IU} in acquiring the first available PRACH occasion in the candidate cell. In one example, the UE may receive candidate cell information/configuration from the source cell and transmit the PRACH preamble to the candidate cell at step 212. A random access response (RAR) delay is expected until an RAR is received at step 213. In one example, if the RAR is needed (i.e., the UE needs to receive the RAR), the UE may receive the RAR for the candidate cell on the serving cell. In another example, if the RAR is not needed (i.e., the UE does not need to receive the RAR), the UE may receive the timing advance (TA) or the TA group (TAG) of the candidate cell from the cell switch command, instead of RAR. That is, the UE obtains the candidate cell's TA information before the interruption 233 starts. After receiving cell switch command at 211c, the UE performs UE processing for reconfiguration 223. At step 214, the UE receives a new TCI state from the network.

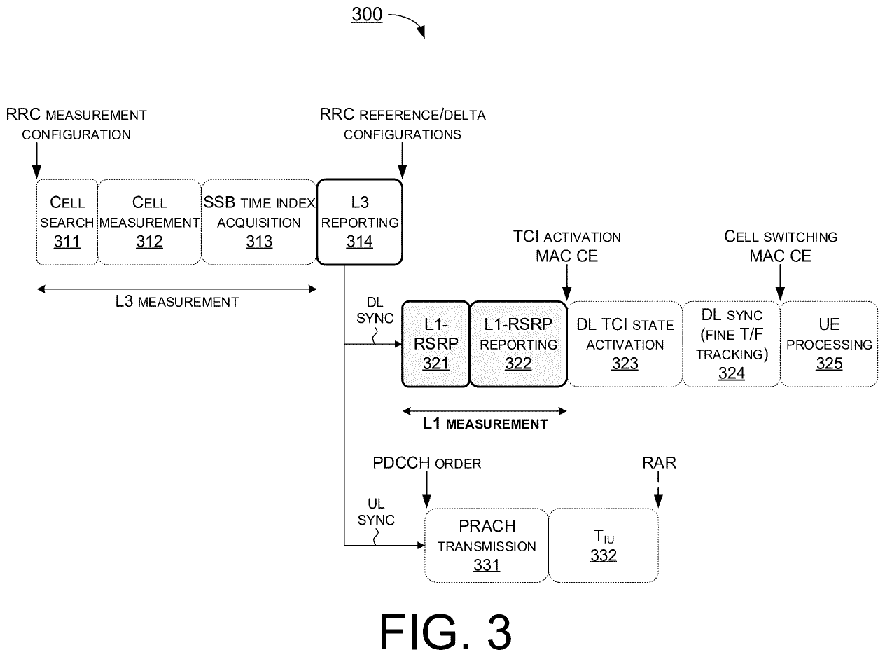

FIG. 3 illustrates an example scenario 300 of DL and UL synchronizations towards candidate cell(s) before the cell switch command in accordance with an implementation of the present disclosure. Scenario 300 involves a series of UE actions related to the LTM procedure, starting from the phase of LTM preparation in which the UE receives the RRC measurement configuration of neighboring cell(s) from the source cell and performs L3 measurement accordingly. The L3 measurement may be broken down into cell search 311, cell measurement 312, and SSB time index acquisition 313. Then, in L3 reporting 314, the UE reports the L3 measurement results to the source cell. After that, the UE receives the RRC reference/delta configurations from the source cell (e.g., via an RRC Reconfiguration message). The RRC reference/delta configurations include candidate cell configurations, such as cell information, and RACH resource information, etc. Subsequently, the UE needs to perform DL synchronization and UL synchronization with the candidate cells before the cell switch command. In detail, the UE performs L1-reference signal received power (RSRP) measurement 321, L1-RSRP reporting 322, and DL TCI state activation 323 (e.g., triggered by a MAC CE for TCI activation), and then DL synchronization 324 to complete fine T/F tracking of the candidate cell(s). Meanwhile, for UL synchronization, the UE performs PRACH transmission 331 upon receiving a PDCCH order indicating a candidate cell for PRACH transmission. UL synchronization also includes the interruption uncertainty T_{IU} in acquiring the first available PRACH occasion in the candidate cell. In one example, if the PDCCH order does not include a cell indicator for indicating a candidate cell for PRACH transmission, it means that the RAR is needed (i.e., the UE needs to receive the RAR), and then the UE may receive the RAR for the candidate cell on the serving cell. In another example, if the PDCCH order does not include a cell indicator for indicating a candidate cell for PRACH transmission, it means that the RAR is not needed (i.e., the UE does not need to receive the RAR), and then the UE may receive the TA information (e.g., TA or TAG) of the candidate cell from the cell switch command. After receiving a cell switch command (e.g., a MAC CE for triggering a cell switch), UE processing 325 is performed for reconfiguration.

Under proposed schemes in accordance with the present disclosure, the UE (e.g., UE 110) may report a first capability indicating a maximum number of cells for L1 measurement to the network (e.g., network node 120), such that the configuration of candidate cell(s) for LTM is configured based on the first capability. After receiving the configuration, the UE may perform L1 measurements on the candidate cell(s) according to the configuration. Specifically, the maximum number of cells may include a maximum number of serving cells, a maximum number of neighboring cells, or a maximum number of serving cells and neighboring cells. In one example, the first capability may indicate a maximum number of cells and whether the cells include the serving cell. If the cells include the serving cell, then we can say that the first capability indicates a maximum number of serving cells and neighboring cells. Otherwise, if the cells do not include the serving cell, then we can say that the first capability indicates a maximum number of neighboring cells. Additionally, or optionally, the UE (e.g., UE 110) may also report a second capability indicating a maximum number of SSBs for L1 measurement to the network (e.g., network node 120). Specifically, the maximum number of SSBs may include a maximum number of SSBs of serving cells, a maximum number of SSBs of neighboring cells, or a maximum number of SSBs of serving cells and neighboring cells.

Alternatively, the UE (e.g., UE 110) may report a third capability indicating a maximum number of activated TCI states for L1 measurement to the network (e.g., network node 120), such that the configuration of candidate cell(s) for LTM is configured based on the third capability. Specifically, the maximum number of activated TCI states may include a maximum number of activated TCI states of serving cells, a maximum number of activated TCI states of neighboring cells, or a maximum number of activated TCI states of serving cells and neighboring cells.

In some implementations, the first/second/third capability may be reported per UE, per frequency range (FR), per band, or per component carrier (CC).

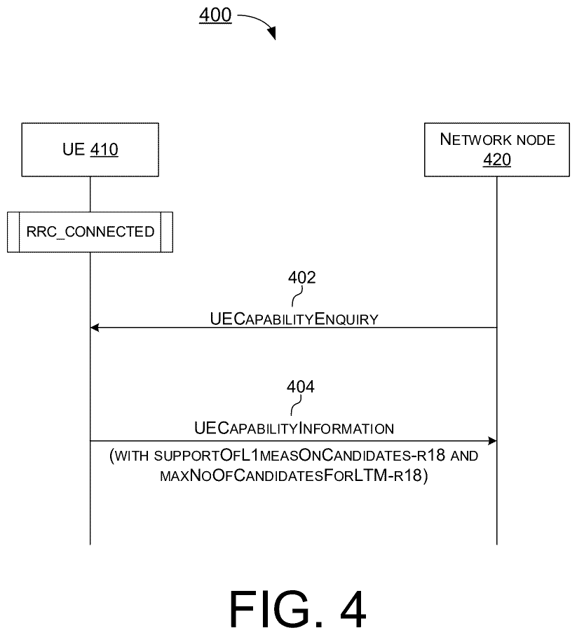

FIG. 4 illustrates an example scenario 400 of UE capability reporting for LTM in accordance with an implementation of the present disclosure. Scenario 400 involves a UE 410 and a network node 420 which may be part of a wireless network (e.g., an LTE network, a 5G NR network, an IoT network, or a 6G network). As shown in FIG. 4, at step 402, the network node 420 initiates the UE capability transfer procedure by transmitting a UECapabilityEnquiry message to the UE 410. Specifically, the UE capability transfer procedure may be initiated when the UE 410 is in the RRC_CONNECTED state and when the network node 420 needs (additional) UE radio access capability information. At step 404, the UE 410 transmits a UECapabilityInformation message to the network node 420. Specifically, the UECapabilityInformation message may contain UE capability information indicating that the UE 410 supports L1-RSRP measurement and reporting based on SSB(s) of candidate cell(s) and indicating a maximum number of RRC configured candidate cell(s) for intra-frequency and inter-frequency L1-RSRP measurement. For example, the UE capability information may be signaled in one or more information elements (IEs), including supportOfL1measOnCandidates-r18 and maxNoOfCandidatesForLTM-r18. The IE supportOfL1measOnCandidates-r18 indicates that the UE 410 supports L1-RSRP measurement and reporting based on SSB(s) of candidate cell(s). The IE maxNoOfCandidatesForLTM-r18 indicates the maximum number of RRC configured candidate cell(s) for intra-frequency and inter-frequency L1-RSRP measurement, that is supported by the UE 410. In other words, the features of L1 measurement for LTM are indicated by the UE capability information reported in the UECapabilityInformation message.

### Illustrative Implementations

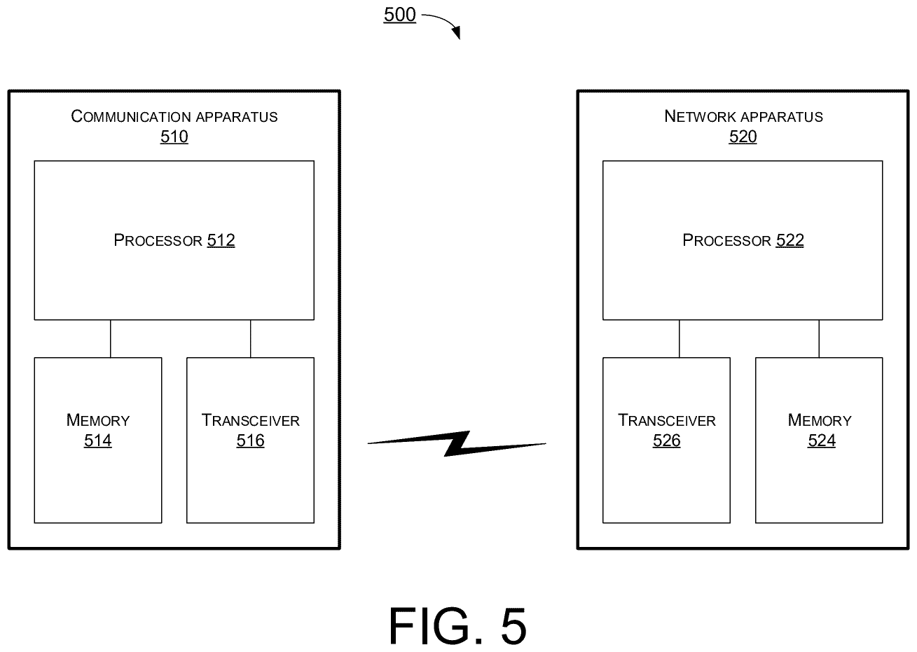

FIG. 5 illustrates an example communication system 500 having an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to UE capability reporting for LTM in mobile communications, including scenarios/schemes described above as well as processes 600 and 700 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, a digital camera, or a computing equipment such as a tablet computer, a laptop computer or a notebook computer. Communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of an electronic apparatus, which may be a network node such as a BS, a small cell, a router or a gateway. For instance, network apparatus 520 may be implemented in an eNB in a 4G LTE network, or a gNB/TRP/RU in a 5G, B 5G, 6G, IoT, NB-IoT or IIoT network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including early UL synchronization for LTM in a UE (e.g., as represented by communication apparatus 510) and a BS (e.g., as represented by network apparatus 520) in accordance with various implementations of the present disclosure.

In some implementations, communication apparatus 510 may also include a transceiver 516 coupled to processor 512 and capable of wirelessly transmitting and receiving control and data signals. In some implementations, transceiver 516 may be capable of wirelessly communicating with different types of BSs of different RATs. In some implementations, transceiver 516 may be equipped with a plurality of antenna ports (not shown) such as, for example, four antenna ports. That is, transceiver 516 may be equipped with multiple transmit antennas and multiple receive antennas for multiple-input multiple-output (MIMO) wireless communications. In some implementations, network apparatus 520 may also include a transceiver 526 coupled to processor 522 and capable of wirelessly transmitting and receiving control and data signals. In some implementations, transceiver 526 may be capable of wirelessly communicating with different types of UEs of different RATs. In some implementations, transceiver 526 may be equipped with a plurality of antenna ports (not shown) such as, for example, four antenna ports. That is, transceiver 526 may be equipped with multiple transmit antennas and multiple receive antennas for MIMO wireless communications. Accordingly, communication apparatus 510 and network apparatus 520 may wirelessly communicate with each other via transceiver 516 and transceiver 526, respectively.

In some implementations, communication apparatus 510 may further include a memory 514 coupled to processor 512 and capable of being accessed by processor 512 and storing data therein. In some implementations, network apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 510 and network apparatus 520 may be a communication entity capable of communicating with each other using various proposed schemes in accordance with the present disclosure. For illustrative purposes and without limitation, a description of operations, functionalities, and capabilities of communication apparatus 510, implemented in or as a UE (e.g., the UE 110), and network apparatus 520, implemented in or as a network node (e.g., the network node 120), is provided below.

According to certain proposed schemes of the present disclosure, processor 512 of communication apparatus 510 may report, via transceiver 516, a first capability indicating a maximum number of cells for L1 measurement to network apparatus 520. Then, processor 512 may receive, via transceiver 516, a configuration of one or more candidate cells for LTM from network apparatus 520. Specifically, the configuration is configured based on the first capability. Also, processor 512 may perform, via transceiver 516, L1 measurements on the candidate cells according to the configuration.

In some implementations, the maximum number of cells may include a maximum number of serving cells, a maximum number of neighboring cells, or a maximum number of serving cells and neighboring cells.

In some implementations, processor 512 may also report, via transceiver 516, a second capability indicating a maximum number of SSBs for L1 measurement to network apparatus 520.

In some implementations, the maximum number of SSBs may include a maximum number of SSBs of serving cells, a maximum number of SSBs of neighboring cells, or a maximum number of SSBs of serving cells and neighboring cells.

In some implementations, the first capability may be reported per UE, per FR, per band, or per CC.

In some implementations, the L1 measurements may be performed before receiving a cell switch command from network apparatus 520.

In some implementations, the cell switch command may include a MAC CE triggering a cell switch.

According to certain proposed schemes of the present disclosure, processor 522 of network apparatus 520 may receive, via transceiver 526, a first capability indicating a maximum number of cells for L1 measurement from communication apparatus 510. Then, processor 522 may transmit, via transceiver 526, a configuration of one or more candidate cells for LTM to communication apparatus 510. Specifically, the configuration is configured based on the first capability.

In some implementations, the maximum number of cells may include a maximum number of serving cells, a maximum number of neighboring cells, or a maximum number of serving cells and neighboring cells.

In some implementations, processor 522 may also receive, via transceiver 526, a second capability indicating a maximum number of SSBs for L1 measurement from communication apparatus 510.

In some implementations, the maximum number of SSBs may include a maximum number of SSBs of serving cells, a maximum number of SSBs of neighboring cells, or a maximum number of SSBs of serving cells and neighboring cells.

In some implementations, the first capability may be reported per UE, per FR, per band, or per CC.

In some implementations, processor 522 may also transmit, via transceiver 526, a cell switch command to communication apparatus 510. Specifically, the cell switch command includes a MAC CE triggering a cell switch.

### Illustrative Processes

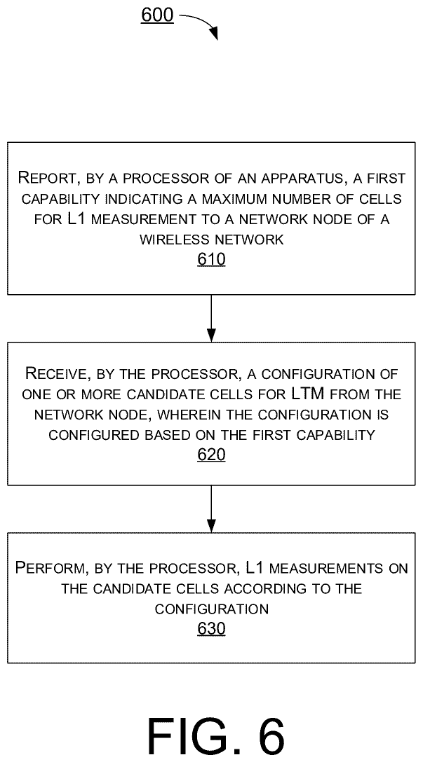

FIG. 6 illustrates an example process 600 in accordance with an implementation of the present disclosure. Process 600 may be an example implementation of above scenarios/schemes, whether partially or completely, with respect to UE capability reporting for LTM in mobile communications. Process 600 may represent an aspect of implementation of features of communication apparatus 510. Process 600 may include one or more operations, actions, or functions as illustrated by one or more of blocks 610, 620, and 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by communication apparatus 510 or any suitable UE. Solely for illustrative purposes and without limitation, process 600 is described below in the context of communication apparatus 510 as a UE and network apparatus 520 as a network node. Process 600 may begin at block 610.

At 610, process 600 may involve processor 512 of communication apparatus 510 reporting, via transceiver 516, a first capability indicating a maximum number of cells for L1 measurement to network apparatus 520. Process 600 may proceed from 610 to 620.

At 620, process 600 may involve processor 512 receiving, via transceiver 516, a configuration of one or more candidate cells for LTM from network apparatus 520, wherein the configuration is configured based on the first capability. Process 600 may proceed from 620 to 630.

At 630, process 600 may involve processor 512 performing, via transceiver 516, L1 measurements on the candidate cells according to the configuration.

In some implementations, the maximum number of cells may include a maximum number of serving cells, a maximum number of neighboring cells, or a maximum number of serving cells and neighboring cells.

In some implementations, process 600 may further involve processor 512 reporting, via transceiver 516, a second capability indicating a maximum number of SSBs for L1 measurement to network apparatus 520.

In some implementations, the maximum number of SSBs may include a maximum number of SSBs of serving cells, a maximum number of SSBs of neighboring cells, or a maximum number of SSBs of serving cells and neighboring cells.

In some implementations, the first capability may be reported per UE, per FR, per band, or per CC.

In some implementations, the L1 measurements may be performed before receiving a cell switch command from network apparatus 520.

In some implementations, the cell switch command may include a MAC CE triggering a cell switch.

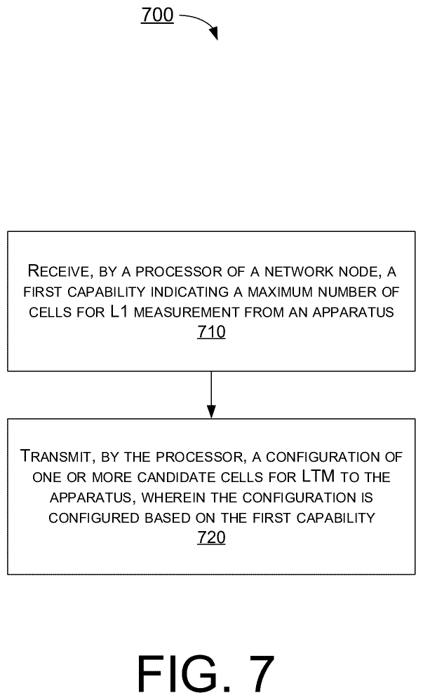

FIG. 7 illustrates an example process 700 in accordance with an implementation of the present disclosure. Process 700 may be an example implementation of above scenarios/schemes, whether partially or completely, with respect to UE capability reporting for LTM in mobile communications. Process 700 may represent an aspect of implementation of features of network apparatus 520. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by network apparatus 520. Solely for illustrative purposes and without limitation, process 700 is described below in the context of communication apparatus 510 as a UE and network apparatus 520 as a network node. Process 700 may begin at block 710.

At 710, process 700 may involve processor 522 of network apparatus 520 receiving, via transceiver 526, a first capability indicating a maximum number of cells for L1 measurement from communication apparatus 510. Process 700 may proceed from 710 to 720.

At 720, process 700 may involve processor 522 transmitting, via transceiver 526, a configuration of one or more candidate cells for LTM to communication apparatus 510, wherein the configuration is configured based on the first capability.

In some implementations, the maximum number of cells may include a maximum number of serving cells, a maximum number of neighboring cells, or a maximum number of serving cells and neighboring cells.

In some implementations, process 700 may further involve processor 522 receiving, via transceiver 526, a second capability indicating a maximum number of SSBs for L1 measurement from communication apparatus 510.

In some implementations, the maximum number of SSBs may include a maximum number of SSBs of serving cells, a maximum number of SSBs of neighboring cells, or a maximum number of SSBs of serving cells and neighboring cells.

In some implementations, the first capability may be reported per UE, per FR, per band, or per CC.

In some implementations, process 700 may further involve processor 522 transmitting, via transceiver 526, a cell switch command to communication apparatus 510, wherein the cell switch command includes a MAC CE triggering a cell switch.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
reporting, by a processor of an apparatus, a first capability indicating a maximum number of cells for layer-1 (L1) measurement to a network node of a wireless network;
receiving, by the processor, a configuration of one or more candidate cells for L1 or layer-2 (L2) triggered mobility (LTM) from the network node, wherein the configuration is configured based on the first capability; and
performing, by the processor, L1 measurements on the candidate cells according to the configuration.

2. The method of claim 1, wherein the maximum number of cells comprises:
a maximum number of serving cells;
a maximum number of neighboring cells; or a maximum number of serving cells and neighboring cells.

3. The method of claim 1, further comprising:
reporting, by the processor, a second capability indicating a maximum number of synchronization signal blocks (SSBs) for L1 measurement to the network node.

4. The method of claim 3, wherein the maximum number of SSBs comprises:
a maximum number of SSBs of serving cells;
a maximum number of SSBs of neighboring cells; or a maximum number of SSBs of serving cells and neighboring cells.

5. The method of claim 1, wherein the first capability is reported per user equipment (UE), per frequency range (FR), per band, or per component carrier (CC).

6. The method of claim 1, wherein the L1 measurements are performed before receiving a cell switch command from the network node.

7. The method of claim 6, wherein the cell switch command comprises a medium access control (MAC) control element (CE) triggering a cell switch.

8. An apparatus, comprising:
a transceiver which, during operation, wirelessly communicates with a network node of a wireless network; and
a processor communicatively coupled to the transceiver such that, during operation, the processor performs operations comprising:
reporting, via the transceiver, a first capability indicating a maximum number of cells for layer-1 (L1) measurement to the network node;
receiving, via the transceiver, a configuration of one or more candidate cells for L1 or layer-2 (L2) triggered mobility (LTM) from the network node, wherein the configuration is configured based on the first capability; and
performing, via the transceiver, L1 measurements on the candidate cells according to the configuration.

9. The apparatus of claim 8, wherein the maximum number of cells comprises:
a maximum number of serving cells;
a maximum number of neighboring cells; or a maximum number of serving cells and neighboring cells.

10. The apparatus of claim 8, wherein, during operation, the processor further performs operations comprising:
reporting, via the transceiver, a second capability indicating a maximum number of synchronization signal blocks (SSBs) for L1 measurement to the network node.

11. The apparatus of claim 10, wherein the maximum number of SSBs comprises:
a maximum number of SSBs of serving cells;
a maximum number of SSBs of neighboring cells; or a maximum number of SSBs of serving cells and neighboring cells.

12. The apparatus of claim 8, wherein the first capability is reported per user equipment (UE), per frequency range (FR), per band, or per component carrier (CC).

13. The apparatus of claim 8, wherein the L1 measurements are performed before receiving a cell switch command from the network node.

14. The apparatus of claim 13 wherein the cell switch command comprises a medium access control (MAC) control element (CE) triggering a cell switch.

15. A method, comprising:
receiving, by a processor of a network node, a first capability indicating a maximum number of cells for layer-1 (L1) measurement from an apparatus; and
transmitting, by the processor, a configuration of one or more candidate cells for L1 or layer-2 (L2) triggered mobility (LTM) to the apparatus, wherein the configuration is configured based on the first capability.

16. The method of claim 15, wherein the maximum number of cells comprises:
a maximum number of serving cells;
a maximum number of neighboring cells; or a maximum number of serving cells and neighboring cells.

17. The method of claim 15, further comprising:
receiving, by the processor, a second capability indicating a maximum number of synchronization signal blocks (SSBs) for L1 measurement from the apparatus.

18. The method of claim 17, wherein the maximum number of SSBs comprises:
a maximum number of SSBs of serving cells;
a maximum number of SSBs of neighboring cells; or a maximum number of SSBs of serving cells and neighboring cells.

19. The method of claim 15, wherein the first capability is reported per user equipment (UE), per frequency range (FR), per band, or per component carrier (CC).

20. The method of claim 15, further comprising:
transmitting, by the processor, a cell switch command to the apparatus, wherein the cell switch command comprises a medium access control (MAC) control element (CE) triggering a cell switch.
